(19) United States
(12) Patent Application Publication
(10) Pub. No.: US 2008/0078065 A1
(43) Pub. Date: Apr. 3, 2008

(54) Assemble type lever handle

(75) Inventors: Lien-Hsi Huang, Kaohsiung City (TW); Kuang-Chun Chiang, Ziguan Shiang (TW)

Correspondence Address: TROXELL LAW OFFICE PLLC;SUITE 1404, 5205 LEESBURG PIKE, FALLS CHURCH, VA, 22041, US

(73) Assignee: Taiwan Fu Hsing Industrial Co., Ltd.

(21) Appl. No.: 11/494,593

(22) Filed: Jul. 28, 2006

(51) Int. Cl. B25G 3/32

(52) U.S. Cl. 16/422

(57) ABSTRACT

An assemble type lever handle comprises a main body and an embedding element. The main body has a casing portion and a cylindrical portion integrally formed by extending from one end of the casing portion. The cylindrical portion has an internal sidewall, an external sidewall and at least one through hole, wherein the through hole forms between the internal sidewall and the external sidewall. The embedding element is inserted into the through hole of the cylindrical portion and has a fixing portion and an internal protruding portion, wherein the fixing portion is fixed to the through hole of the cylindrical portion and the internal protruding portion is protruded from the internal sidewall of the cylindrical portion. In addition, the assemble type lever handle further comprises a cover plate jointed to the casing portion of the main body.

### FIELD OF THE INVENTION

The present invention relates to a lever handle, and more particularly to an assemble type lever handle with at least one embedding element.

### BACKGROUND OF THE INVENTION

In general, a conventional lever handle is manufactured by a casting method, and thus causing a heavier weight and incurring a higher cost. Therefore, a handle as disclosed in R.O.C. Pat. Publication No. 00327911 is provided for improving the difficulties of manufacturing handles. The handle is comprised of a main body, a first half element and a second half element, and the main body is clamped by the first and second half elements, and thus the elements are frequently collided with each other and deformed during an assembling process. As a result, such arrangement makes the assembling difficult and causes a poor weld. Furthermore, the forces exerted onto the whole handle are concentrated at the position where the first and second half elements clamp the main body, and thus the first and second half elements may be separated from each other after a long term of use, and the handle cannot be used anymore.

### SUMMARY

The primary object of this invention is to provide an assemble type lever handle that comprises a main body and at least one embedding element, and the main body has a casing portion and a cylindrical portion, and the cylindrical portion is integrally formed by extending from one end of the casing portion, and the cylindrical portion has an internal sidewall, an external sidewall and at least one through hole. The embedding element is inserted into the through hole of the cylindrical portion, and the embedding element has a fixing portion, an internal protruding portion and a top surface, wherein the fixing portion is fixed to the through hole of the cylindrical portion, and the internal protruding portion is protruded from the internal sidewall of the cylindrical portion. Preferably, the assemble type lever handle further comprises a cover plate joined to the casing portion of the main body. The assemble type lever handle of the present invention latches a turning shaft and drives the turning shaft to rotate via the internal protruding portion of the embedding element. Besides lowering the level of difficulty of the manufacturing process, this arrangement also can connect the embedding element securely with the cylindrical portion of the main body, and thus greatly enhancing the connection between the assemble type lever handle and the turning shaft.

The secondary object of this invention is to provide an assemble type lever handle, wherein the cover plate has an opening corresponding to the cylindrical portion of the main body for accommodating a lock, a knob, or a push button.

A further object of this invention is to provide an assemble type lever handle that further comprises a cover layer, the external sidewall of the cylindrical portion and the top surface of the embedding element are covered with the cover layer, such that the assemble type lever handle has a smooth and level surface.

The structure of an assemble type lever handle in accordance with the present invention comprises a main body, at least one embedding element and a cover plate. The main body has a casing portion and a cylindrical portion, and the cylindrical portion is integrally formed by extending from one end of the casing portion, and the cylindrical portion has an internal sidewall, an external sidewall and at least one through hole. The embedding element is inserted into the through hole of the cylindrical portion, and the embedding element has a fixing portion, an internal protruding portion and a top surface, wherein the fixing portion is fixed to the through hole of the cylindrical portion, and the internal protruding portion is protruded from the internal sidewall of the cylindrical portion, and the cover plate is joined to the casing portion of the main body.

### DESCRIPTION OF THE DRAWINGS

FIGS. 1A to 1C are schematic views of an assemble type lever handle in accordance with a preferred embodiment of the present invention.

FIG. 2A is a cross-sectional view of a main body in accordance with a preferred embodiment of the present invention.

FIG. 2B is a cross-sectional view taken along line 2B-2B of FIG. 1B of the main body with at least one embedding element installed.

FIG. 2C is a cross-sectional view of a cover plate joined to a main body in accordance with a preferred embodiment of the present invention.

FIGS. 3A and 3B are schematic views of a manufacturing process of removing an exposed portion in accordance with another preferred embodiment of the present invention.

FIG. 4 is a cross-sectional view of forming a cover layer in accordance with a further preferred embodiment of the present invention.

FIG. 5 is an exploded view of an assemble type lever handle in accordance with another preferred embodiment of the present invention.

### DETAILED DESCRIPTION OF THE PRESENT INVENTION

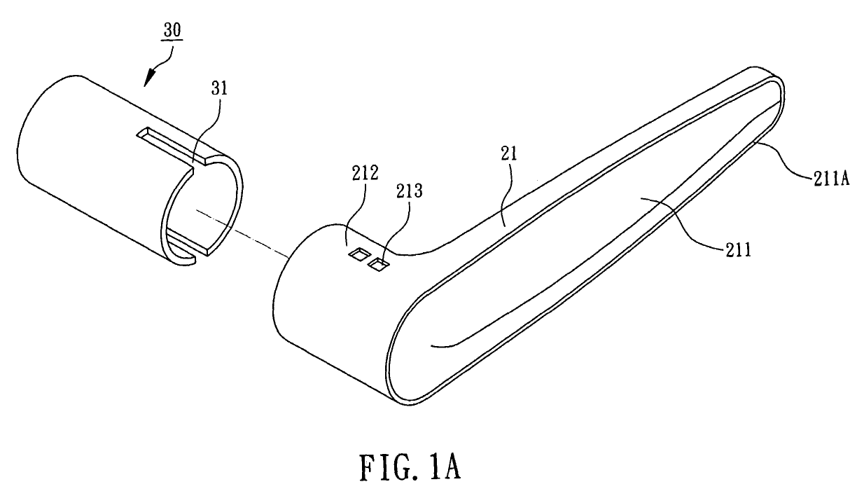

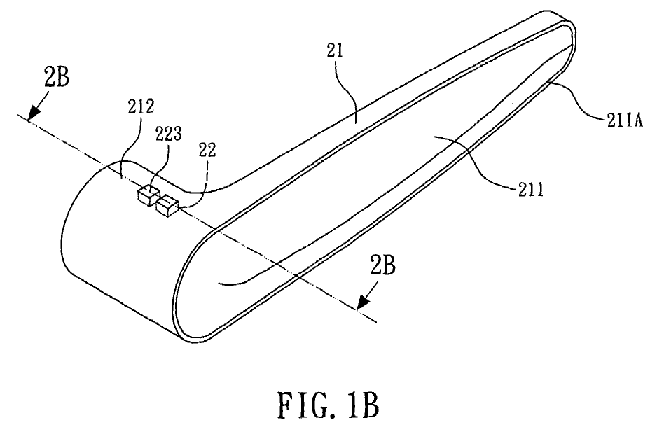

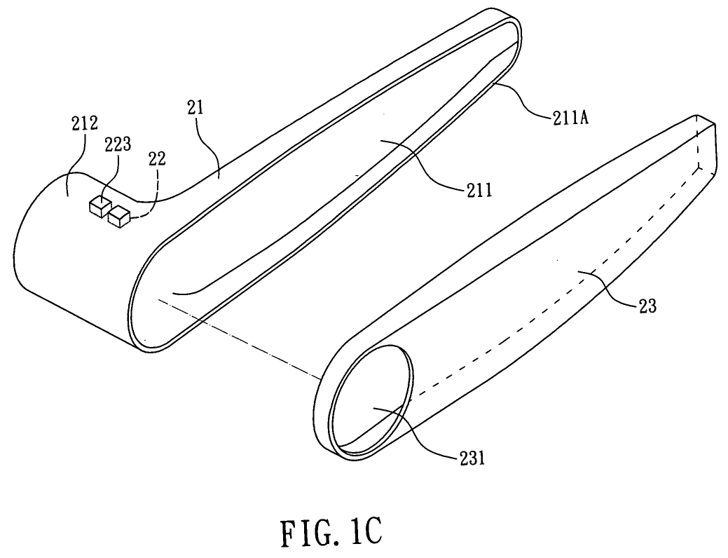

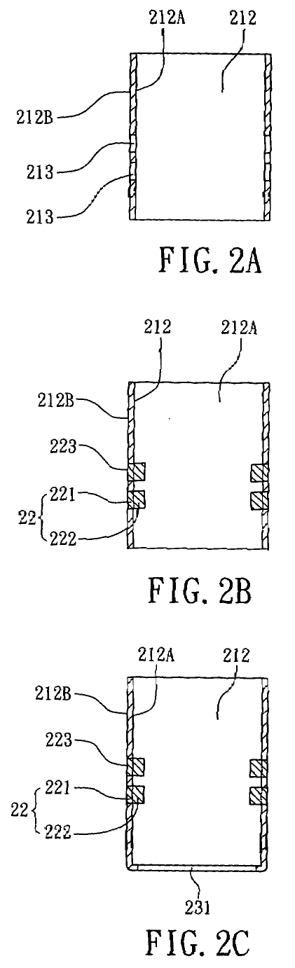

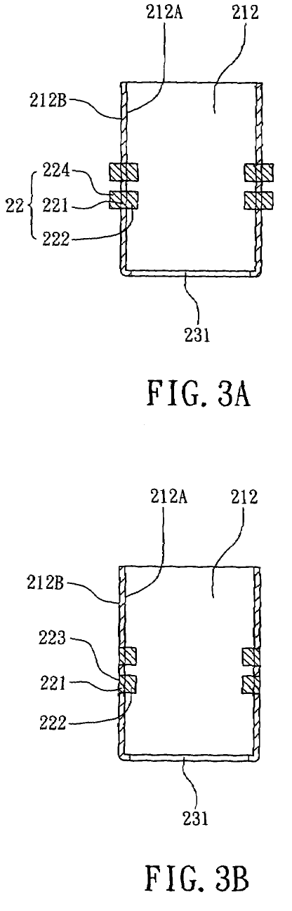

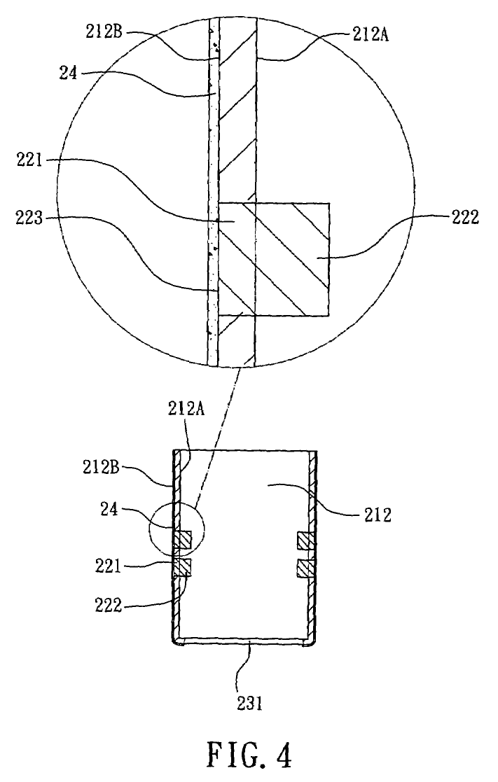

Referring to FIGS. 1A, 1C, 2A and 2C, a method for manufacturing an assemble type lever handle 20 in accordance with a preferred embodiment of the present invention is disclosed. To begin with, providing a main body 21 as shown in FIGS. 1A and 2A, and the main body 21 has a casing portion 211 and a cylindrical portion 212, and the cylindrical portion 212 is integrally formed by extending from one end of the casing portion 211, and the cylindrical portion 212 is provided for driving a turning shaft 30 to rotate, such that the turning shaft 30 can rotate to drive a pin of a lock to move forward and backward. The cylindrical portion 212 has an internal sidewall 212A, an external sidewall 212B and at least one through hole 213 formed between the internal sidewall 212A and the external sidewall 212B, and the through hole 213 can be a square shape, a rectangular shape, a circular shape, or another geometric shape. Preferably, the main body 21 is made by punching a metal sheet (not shown in the figures). And then inserting at least one embedding element 22 into the through hole 213 of the cylindrical portion 212 as shown in FIGS. 1B and 2B. In this embodiment, the embedding element 22 has a fixing portion 221, an internal protruding portion 222 and a top surface 223, wherein the fixing portion 221 is fixed to the through hole 213 of the cylindrical portion 212 and the internal protruding portion 222 is protruded from the internal sidewall 212A of the cylindrical portion 212. The embedding element 22 is inserted into the through hole 213 of the cylindrical portion 212 as a tight fit, and the top surface 223 of the embedding element 22 is substantially even with the external sidewall 212B of the cylindrical portion 212, and the embedding element 22 could be a pin, a needle or a block member and is a bar shape or a cylindrical shape. Preferably, the embedding element 22 is soldered and fixed to the through hole 213 of the cylindrical portion 212 by a soldering material, or in another embodiment, the embedding element 22 is adhered and fixed to the through hole 213 of the cylindrical portion 212 by an adhesive. A cover plate 23 is jointed to the casing portion 211 of the main body 21 as shown in FIGS. 1C and 2C, and the cover plate 23 is made by punching a metal sheet (not shown in the figures). In this embodiment, the cover plate 23 is jointed to the casing portion 211 of the main body 21 by way of soldering or adhering, to enable the assemble type lever handle 20 to form a hollow space (not shown in the figures) used to lighten the weight of the assemble type lever handle 20 and reduce the manufacturing cost thereof. The casing portion 211 has a surrounding flange 211A, and the cover plate 23 of this embodiment has an opening 231 corresponding to the cylindrical portion 212 of the main body 21 for accommodating a lock, a knob or a push button. The cover plate 23 is jointed to the surrounding flange 211A of the casing portion 211 by way of soldering or adhering. In addition, a surface treatment is performed to provide a smooth and level surface of the assemble type lever handle 20, and the surface treatment could be a polishing process, an electroplating process or a baking paint process. Referring to FIGS. 3A and 3B for another embodiment, the embedding element 22 has a fixing portion 221, an internal protruding portion 222 and an exposed portion 224, wherein the exposed portion 224 is protruded from the external sidewall 212B of the cylindrical portion 212, so that after the embedding element 22 is soldered or adhered to the through hole 213 of the cylindrical portion 212, the exposed portion 224 of the embedding element 22 is removed by way of grinding, and the top surface 223 of the embedding element 22 is substantially even with the external sidewall 212B of the cylindrical portion 212 after removing the exposed portion 224. After removing the exposed portion 224, a surface treatment is performed for the assemble type lever handle 20, so that the assemble type lever handle 20 has a smooth and level surface. Referring to FIGS. 3A and 4, the assemble type lever handle 20 of this embodiment further comprises a cover layer 24, the external sidewall 212B of the cylindrical portion 212 and the top surface 223 of the embedding element 22 are covered with the cover layer 24 to beautify the assemble type lever handle 20, and the cover layer 24 is an electroplated layer or a baked coating layer formed by the surface treatment. Furthermore, after removing the exposed portion 224 by way of grinding, the top surface 223 of the embedding element 22 forms a rough surface (not shown in the figures) used to enhance the adhesion between the top surface 223 and the cover layer 24. On the other hand, the exposed portion 224 can directly covered with the cover layer 24 without being removed.

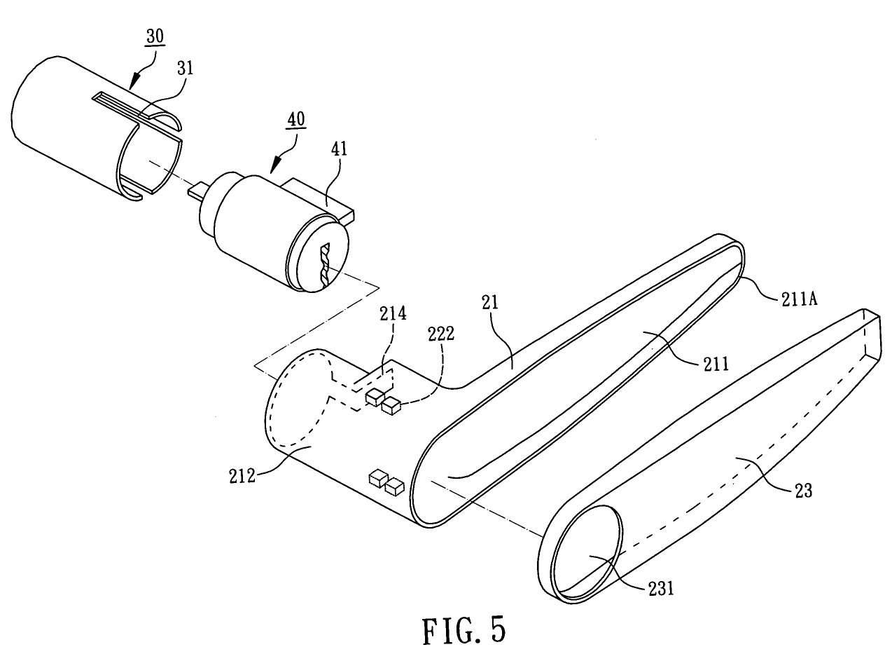

Referring to FIG. 5, the assemble type lever handle 20 connects with a lock 40 in accordance with the present invention, the lock 40 is installed in the turning shaft 30, and a latching slot 31 of the turning shaft 30 is provided for latching the embedding element 22, and the cylindrical portion 212 of the main body 21 has a positioning slot 214 for embedding and positioning a positioning member 41 of the lock 40 into the positioning slot 214.

Referring to FIGS. 1C, 2C and 4, an assemble type lever handle 20 of the present invention comprises a main body 21 and at least one embedding element 22, and the main body 21 has a casing portion 211 and a cylindrical portion 212, and the cylindrical portion 212 is integrally formed by extending from one end of the casing portion 211, and the cylindrical portion 212 has an internal sidewall 212A, an external sidewall 212B and at least one through hole 213, wherein the through hole 213 forms between the internal sidewall 212A and the external sidewall 212B. The embedding element 22 is inserted into the through hole 213 of the cylindrical portion 212, and the embedding element 22 has a fixing portion 221, an internal protruding portion 222 and a top surface 223. The fixing portion 221 is fixed to the through hole 213 of the cylindrical portion 212, and the internal protruding portion 222 is protruded from the internal sidewall 212A of the cylindrical portion 212, and the top surface 223 of the embedding element 22 is substantially even with the external sidewall 212B of the cylindrical portion 21. The assemble type lever handle 20 further comprises a cover plate 23 jointed to the casing portion 211 of the main body 21 by latching, soldering, or adhering. The casing portion 211 of this embodiment has a surrounding flange 211A, and the cover plate 23 is jointed to the surrounding flange 211A of the casing portion 211. Besides, the assemble type lever handle 20 as shown in FIG. 4 further comprises a cover layer 24, the external sidewall 212B of the cylindrical portion 212 and the top surface 223 of the embedding element 22 are covered with the cover layer 24. The assemble type lever handle 20 of the present invention latches the latching slot 31 of the turning shaft 30 and drives the turning shaft 30 to rotate via the internal protruding portion 222 of the embedding element 22.

While the present invention has been particularly illustrated and described in detail with respect to the preferred embodiments thereof, it will be clearly understood by those skilled in the art that various changed in form and details may be made without departing from the spirit and scope of the present invention.

What is claimed is:

1. An assemble type lever handle, comprising:
a main body having a casing portion and a cylindrical portion integrally formed by extending from one end of the casing portion, the cylindrical portion has an internal sidewall, an external sidewall and at least one through hole formed between the internal sidewall and the external sidewall; and
at least one embedding element inserted into the through hole of the cylindrical portion and having a fixing portion, an internal protruding portion and a top surface, wherein the fixing portion is fixed to the through hole of the cylindrical portion and the internal protruding portion is protruded from the internal sidewall of the cylindrical portion.

2. The assemble type lever handle of claim 1, further comprising a cover plate, jointed to the casing portion of the main body to enable the assemble type lever handle to form a hollow space.

3. The assemble type lever handle of claim 2, wherein the cover plate is jointed to the casing portion of the main body by way of soldering.

4. The assemble type lever handle of claim 2, wherein the cover plate is jointed to the casing portion of the main body by way of adhering.

5. The assemble type lever handle of claim 2, wherein the casing portion has a surrounding flange, and the cover plate is jointeded to the surrounding flange of the casing portion.

6. The assemble type lever handle of claim 5, wherein the cover plate is jointed to the surrounding flange of the casing portion by way of soldering.

7. The assemble type lever handle of claim 5, wherein the cover plate is jointed to the surrounding flange of the casing portion by way of adhering.

8. The assemble type lever handle of claim 2, wherein the cover plate has an opening corresponding to the cylindrical portion of the main body.

9. The assemble type lever handle of claim 1, further comprising a cover layer, wherein the external sidewall of the cylindrical portion and the top surface of the embedding element are covered with the cover layer.

10. The assemble type lever handle of claim 9, wherein the cover layer is an electroplated layer or a baked coating layer.

11. The assemble type lever handle of claim 9, wherein the embedding element has an exposed portion protruded from the external sidewall of the cylindrical portion.

12. The assemble type lever handle of claim 11, wherein the exposed portion is covered with the cover layer.

13. The assemble type lever handle of claim 1, wherein the top surface of the embedding element is substantially even with the external sidewall of the cylindrical portion.

14. The assemble type lever handle of claim 1, wherein the embedding element is a pin, a needle or a block member.

15. The assemble type lever handle of claim 1, wherein the embedding element is a bar shape or a cylindrical shape.

16. The assemble type lever handle of claim 1, wherein the embedding element is soldered and fixed to the through hole of the cylindrical portion by a soldering material.

17. The assemble type lever handle of claim 1, wherein the embedding element is adhered and fixed to the through hole of the cylindrical portion by an adhesive.

18. The assemble type lever handle of claim 1., wherein the through hole of the cylindrical portion can be a square shape, a rectangular shape, a circular shape or another geometric shape.
